(19) United States
(12) Patent Application Publication
(10) Pub. No.: US 2009/0094528 A1
(43) Pub. Date: Apr. 9, 2009

(54) USER INTERFACES AND UPLOADING OF USAGE INFORMATION

(75) Inventors: Jim Gray, Albany, CA (US); Dean Burris, Kensington, CA (US); Marni Taradash, Alameda, CA (US); Jeffrey G. Katz, Manhattan Beach, CA (US); Jeff Grant, Sausalito, CA (US)

Correspondence Address: MURABITO, HAO & BARNES, LLP, TWO NORTH MARKET STREET, THIRD FLOOR, SAN JOSE, CA, 95113, US

(73) Assignee: LEAPFROG ENTERPRISES, INC., Emeryville, CA (US)

(21) Appl. No.: 12/119,018

(22) Filed: May 12, 2008

Related U.S. Application Data
(60) Provisional application No. 60/998,030, filed on Oct. 5, 2007.

(51) Int. Cl. G06F 3/048

(52) U.S. Cl. 715/745

(57) ABSTRACT

A graphical user interface (GUI) can be used to provide information reflecting a user's interaction with a product using a stand-alone portable device. The user can respond to questions while interacting with the product. The responses are logged by the portable device and subsequently uploaded to the computer system, which forwards them via the Internet to a server. The computer system also forwards registration information to the server. The registration information identifies the user and the product. Based on information received from the server, the computer system generates a GUI that includes a report summarizing the information forwarded from the computer system, including the name of the product the user was interacting with, and that also includes names of additional products selected based on the forwarded information.

### RELATED U.S. APPLICATIONS

This application claims priority to the copending provisional patent application by J. Gray et al., Ser. No. 60/998,030, filed on Oct. 5, 2007, with Attorney Docket No. LEAP-P0406.PRO, entitled “User Interfaces and Upload of Usage Information,” assigned to the assignee of the present application, and hereby incorporated by reference in its entirety.

This application is related to the copending U.S. Patent Application by J. Gray et al., Ser. No. ______, filed on ______, with Attorney Docket No. LEAP-P0408, entitled “Methods and Systems That Monitor Learning Progress,” assigned to the assignee of the present invention, and hereby incorporated by reference in its entirety.

### BACKGROUND

There are a number of innovative, technology-based devices that make learning more fun and engaging. These types of devices include gaming platforms, particularly handheld devices, that are used mostly by children to play educational video games. Subjects such as math, reading, science, social studies, music, geography and spelling are taught and reinforced as part of the gameplay. These types of devices also include “touch-and-talk” devices that use a small, sophisticated imaging system to sense and recognize patterns printed on the pages of books. By touching a touch-and-talk device on any page of an appropriately formatted book, words, lines and entire stories can be heard.

The effectiveness of technology-based learning devices and related products can be increased by giving parents the capability to see and measure what their children have worked on and are actually learning, so that progress can be tracked and areas of strength as well as areas where extra attention may be needed can be identified. An example of a product that provides such capability is Mind Station™ by LeapFrog®.

### SUMMARY

According to embodiments of the present invention, a portable device, operable as a stand-alone device (e.g., a handheld gaming device or a touch-and-talk device), logs inputs (e.g., responses) by a user (e.g., a child) while the user is using the device to interact with a product (e.g., a video game or book compatible with the device). The portable device can subsequently be linked to an end-user device (e.g., a personal computer), so that the logged responses (which may be processed by the end-user device) can be uploaded and then forwarded to the user's account at a server (e.g., a Web server) via an Internet connection, for example. Other types of information, such as report cards and standardized test scores, can also be uploaded and forwarded to the server.

Registration information, including information that identifies the user (e.g., a user profile), the product (e.g., a title) and the portable device, can also be sent to the server. A report specific to the user and summarizing the user response information forwarded to the server can be displayed on the end-user device. This process is similarly performed for each user and for each device/platform and product used. In this manner, each user's performance across multiple devices and products can be logged, summarized and displayed. By doing so, a parent, for instance, can track a child's progression through a variety of learning products covering a variety of curriculum. The progression, or “learning path,” can also provide feedback to the parent regarding other (e.g., next step) products that are appropriate for the child. Each user's information is securely protected so that only persons authorized to access a user's profile and performance information can do so.

The user-specific report, which may also be called a summary of usage report, includes information such as, but not limited to, the user's name, curriculum, devices and products used, the length of time and the number of times each product is used, percentage of right answers and percentage of wrong answers per product used, and the number of times a product's help function is invoked. The summary of usage report is not necessarily a one-time summative report; instead, results can be reported for different time intervals (e.g., on a weekly basis). The summary of usage report can be viewed by a parent and used to assess skills and provide other insights into a child's performance and interests. The child may also view the usage report. Because the report is server-based (e.g., Web-based), it can be viewed from virtually any location via the Internet. As such, authorized persons such as teachers can also access the Web-based information and provide feedback and recommendations. In essence, each child has a specific Web page devoted to the child's learning, providing a centralized and readily accessible resource that can be used to facilitate and monitor the child's progress.

Furthermore, along with the summary of usage report (or incorporated within the report), user-specific recommendations for additional devices, products and activities can be provided. For example, the names of additional products, other than those already registered with the user's account, can be displayed. Recommended activities may include activities that can be performed without using the portable device; for example, links can be provided to printable worksheets that are completed manually instead of electronically. The skill areas each product or activity is designed to promote can also be listed. The suggested devices, products and activities may be related to those already being used by the user, or they may be targeted to the user based on, for example, the user's profile, interests and performance, to help the user progress through the current task/skill level and on to the next level. Accordingly, products and devices can be selected to customize the curricular content for the user.

Moreover, information in the summary of usage report, as well as other information about the user, can be used to customize the curricular content of a particular product to the user's skill/task level. The customized content can be in the form of standardized data structures that are used across multiple applications on a single platform and across multiple platforms. In essence, products can be actively molded for the user based on the user's performance as measured by the information logged by the portable device. The products can also be actively molded based on input from parents, educators and other third parties.

The information described above can be presented in a user-friendly format (e.g., a Web-based graphical user interface or GUI). In addition to presenting the information described above, the GUI provides additional information related to the skills the products are designed to promote. For example, the skill sets the child has engaged with can be highlighted. In one embodiment, the GUI includes a color-coded mapping that associates the skills each product is designed to promote with respective subject areas (e.g., math, reading, etc.), such that all skills associated with a particular subject area are associated with the same color. In one such embodiment, the subset of skills associated with a particular product is highlighted in some manner. In other words, when a user selects (e.g., uses a mouse to click on) a product, for example, the subset of skills that are taught and reinforced through use of that product is highlighted in the GUI.

In summary, according to embodiments of the present invention, parents can be better informed about their child's interests and skills. Parents can monitor their children's learning progress and share in their children's accomplishments. Also, parents are able to personalize and guide each child's learning process to reinforce areas of strength and address areas where more work is needed. Parents can choose from suggested products and devices to fill gaps in their child's curriculum or to address specific areas of study.

These and other objects and advantages of the present invention will be recognized by one skilled in the art after having read the following detailed description, which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an example of a system upon which embodiments according to the present invention can be implemented.

FIGS. 2, 3, 4, 5, 6 and 7 are examples of on-screen graphical user interfaces according to embodiments of the invention.

FIG. 8 is a flowchart of a computer-implemented method for monitoring a user's learning progress according to an embodiment of the invention.

### DETAILED DESCRIPTION

Reference will now be made in detail to embodiments in accordance with the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as, but not limited to, “forwarding” or “receiving” or “storing” or “uploading” or “displaying” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

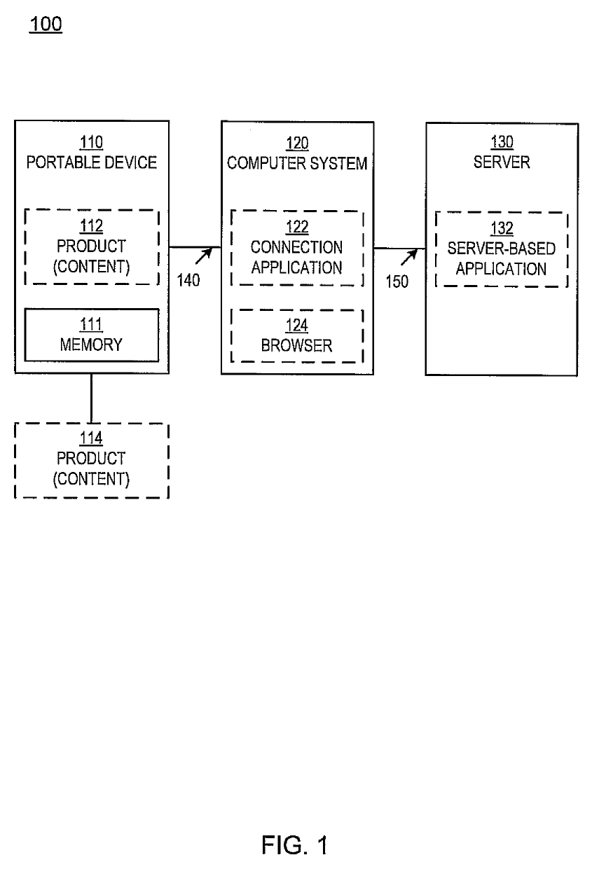

FIG. 1 is a block diagram of an example of a system 100 upon which embodiments according to the present invention can be implemented. In the example of FIG. 1, the system 100 includes a portable electronic device 110, a host computer system 120, and a remote server 130.

The portable device 110 can be operated as a stand-alone device—that is, in order to operate, the portable device does not need to be connected to the computer system 120.

In the discussion below, the term “product” is used in reference to, for example, software applications, proprietary or protected content and the like that may be implemented as, for example, books and video games (e.g., “learning games”), while the term “device” is used to refer to the hardware elements that execute products. It is recognized that, in a sense, a device is also a product, but for ease of discussion, the terms “device” and “product” may be used as just described when it is necessary to make a distinction between a device and a product. As used herein, a “learning game” includes a game that, when played on the portable device 110, elicits responses from a user that may be right or wrong, by asking questions, for example. Learning games perform the above, in general, in connection with interactive audio and/or visual presentations to the user, and the user responds by, for example, pushing a button or touching a screen.

In one embodiment, the portable device 110 is embodied as a handheld gaming device or platform. In one such embodiment, a video game cartridge or the like (e.g., the product/content 112) is inserted into the portable device 110. In another embodiment, software is downloaded to the portable device 110 via a wired or wireless connection to, for example, the computer system 120. In a gaming type of embodiment, the portable device 110 is equipped with video and audio capability and also with appropriate controls that allow a user to interact with the product 112. As will be elaborated on below, the portable device 110 also incorporates a memory 111 that logs certain user inputs (e.g., user responses or actions/activities) while the user is using the portable device 110 to interact with the product 112. The portable device 110 also incorporates other components of a basic computer system, such as a processor (not shown). Examples of handheld gaming devices like the portable device 110 include, but are not limited to, the Leapster 2™, the Crammer™ and the Didj™, all by LeapFrog®. Alternatively, the portable device 110 may be implemented as, or as part oft a laptop or notebook computer system, cell phone, personal digital assistant, or portable media player.

In another embodiment, the portable device 110 is embodied as a pen-shaped computer system or touch-and-talk device, such as, but not limited to, the Tag™ reader by LeapFrog®. In such an embodiment, the portable device 110 includes an imaging system (not shown) that captures light reflected off a surface. In the present embodiment, the portable device 110 is used with a sheet of “digital paper” on which a pattern of markings—specifically, very small dots—are printed. The imaging system essentially takes a snapshot of the surface of the digital paper. By interpreting the positions of the dots captured in each snapshot, the portable device 110 can precisely determine its position on the page in two dimensions. The pattern of dots allows the dynamic position information coming from the imaging system to be processed into signals that are indexed to instructions or commands that can be executed by a processor in the portable device 110.

In a touch-and-talk embodiment, the portable device 110 is used with a compatible product (e.g., the product/content 114) such as a book that is printed on digital (encoded) paper. In such an embodiment, the portable device 110 may also incorporate content (e.g., the product/content 112) that allows it to interpret the content 114. The content 112 may be preloaded onto the portable device 110, or it may be subsequently loaded onto the portable device by the user (e.g., the combination of the content 112 and the content 114 may be purchased together, and the content 112 may then be loaded onto the portable device 110). As in the gaming embodiments described above, the memory 111 can log certain user inputs while the user is using the portable device 110 to interact with the product 114.

As shown in FIG. 1, the portable device 110 can be coupled to the computer system 120 by an interface 140. The interface 140 may be a Universal Serial Bus (USB) connection, although the present invention is not so limited. The portable device 110 can be linked to the computer system 120 in any of a variety of ways, including wirelessly.

In the example of FIG. 1, the computer system 120 incorporates a connection application 122 and a browser 124 (e.g., a Web browser), and the server 130 (e.g., a Web server) incorporates a server-based application 132. The functionalities of the connection application 122 and the server-based application 132, respectively, are described below by way of example. The computer system 120 and the server 130 communicate over the Internet via the interface 150.

In operation, the system 100 can be used as follows. At some point in time, a user accesses the server-based application 132 (e.g., a Web site) in a conventional manner (e.g., using a Uniform Resource Locator) in order to register with the server-based application and set up an account. The user may register prior to the process to be described below or as part of that process. A user-specific profile, containing a user name and perhaps other information such as the user's age and e-mail address, can be created during registration and included in the account. There can be multiple users and user profiles associated with a single account.

Connectable (enabled) devices—e.g., devices such as the portable device 110 that have the capability for online connectivity via the computer system 120 in the manner described below—can also be registered with the account. Thus, the account and each user profile can contain information that identifies the user's devices that are compatible with the connection application 122 and therefore also compatible with the server-based application 132.

After the initial registration is complete, the account can be subsequently accessed by entering the user name and a password, for example. Because the account and user profile information reside on the server 130, the account can be accessed from virtually any location via an Internet connection.

If the portable device 110 is a gaming device, then the user (in particular, a child, although the present invention is not so limited) chooses a particular video game (represented as the product 112) to play and, in one embodiment, inserts the game cartridge into the portable device. Alternatively, the game may be downloaded as software via either a wired or wireless connection to, for example, the computer system 120. If the portable device 110 is a touch-and-talk device, then the user may choose to read, for example, a particular book that is compatible with such a device (represented as the product 114). By scanning an appropriate identifier associated with the product 114, the portable device 110 can identify the name of the product and invoke the corresponding onboard software (represented as the product 112).

The products 112/114 are educational in nature but also provide high entertainment value to encourage the user to remain engaged with the product. While the user interacts (plays) with the chosen product 112/114, the user may be prompted at various points to respond to questions or to perform various activities (e.g., solve puzzles and problems) as part of the gameplay or reading experience. For example, in a book geared to teaching language and literacy, the user may be prompted to identify a particular word within the context of the book. The user responds to the prompt using the portable device 110. For example, in a touch-and-talk embodiment, the user touches the portable device 110 to the appropriate word in the product (book) 114.

Significantly, the user's inputs (responses and actions) to the prompts and questions are recorded (logged) in the memory 111 of the portable device 110. Other information may be recorded. For example, the amount of time that the user is using the particular product (device and/or game/book) can be recorded. Periodically, such as when the user finishes playing with the portable device 110 or with a particular product (e.g., a game or book), the portable device can be connected to the computer system 120 and the information recorded by the portable device can be uploaded to the computer system. The connection application 122 serves as middleware that facilitates both the connection between the computer system 122 and the portable device 110 and the uploading of information from the portable device to the computer system.

In turn, the computer system 120 can forward the recorded information, or information based on that information, to the server 130. That is, for example, the computer system 120 can send the raw responses to the server 130, or the computer system can perform some rudimentary processing of the responses and then send the processed responses to the server 130. The portable device 110 may also perform some processing of the recorded information. For example, instead of simply forwarding the raw responses to the server 130, the connection application 122 may identify which responses are correct or incorrect. In general, the connection application 122 facilitates the transfer of the user's response data and other recorded information from the computer system 120 to the server 130, and may also perform some processing of the recorded information.

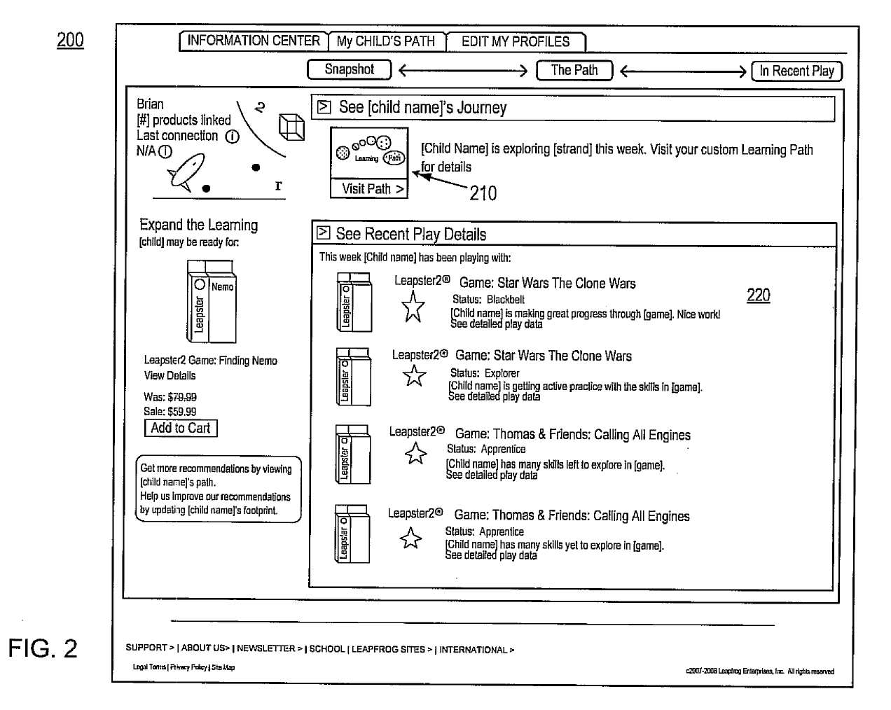

In this manner, the user's online account is populated with the user's response data and other recorded information. New data can be aggregated with any of the user's data that was previously submitted to the account. Within the account, the user's data can be aggregated and then presented in a number of different ways by the server-based application 132. For example, data can be aggregated by the time period in which it was collected (e.g., on a weekly basis), by product (e.g., per video game or per book), by skill set, and/or by subject area. Additional information is provided in conjunction with FIGS. 2-7, below.

In overview, the processed user data is summarized in a user-specific report, which may also be called a summary of usage report. The summary of usage report can include information such as, but not limited to, the user's name, curriculum, devices and products used, the length of time and the number of times each product is used, percentage of right answers and percentage of wrong answers per product used, and the number of times a product's help function is invoked. In essence, the summary of usage can include any type of information logged by the portable device 110 of FIG. 1 or that can be derived from that information. The summary of usage report also can provide a framework for inputting other information, such as standardized test scores and report card grades.

The summary of usage report can be accessed via the Internet and viewed by a parent, teacher or other authorized persons including the child. Because the report is server-based (e.g., Web-based), it can be viewed from virtually any location via the Internet. The summary of usage report can be used as a basis to assess skills and to gain other insights into a child's performance and interests. Also, authorized persons such as teachers can access the Web-based information and provide feedback and recommendations. In essence, each child has a specific Web page devoted to the child's learning, providing a centralized and readily accessible resource that can be used to facilitate and monitor the child's learning progress.

To summarize to this point, using the connection application 122 and the server-based application 132, parents can create an individualized profile for each child. Each time the child finishes playing with an enabled (connectable) device such as the portable device 110, the device can be connected to the computer system 120 so that information logged by the device can be uploaded and forwarded to the server-based application 132. The newly logged data can be aggregated with previous data so that parents can readily review their child's current level of learning as well as the child's learning progress. Parents are able to determine, among many other things, how often their child plays a particular game or reads a particular book, what kinds of questions they responded to, the particular skills that are being taught and practiced, and how well (correctly) they responded.

Furthermore, along with the summary of usage report, recommendations targeted to the user can be provided. In general, the recommendations are intended to help the user progress to the next level of learning. Specifically, devices and products in addition to those already registered with the account can be suggested (displayed). The suggested devices and products may be related to those already registered with the account, or they may be targeted to the user based on, for example, the user's profile, interests and performance, to help the user progress through the current task/skill level and on to the next level.

Progress of a child can be measured in a number of ways such as (1) determining the number of skills with which the child has engaged in a single product or across multiple products, (2) recognizing that the child has engaged with skills above the child's grade level, (3) measuring that the child has spent a specific amount of time using a particular product, (4) measuring the percentage of correct answers or the percentage of incorrect answers, (5) determining that the child has engaged all questions in a product, regardless of whether the child has responded to all questions correctly, and/or (6) recognizing that the child has been through the same questions in a product a predetermined number of times, thus indicating that the potential for the child to learn from the product has decreased—also referred to as product fatigue. As used above in this paragraph, “engage” means that the child has interacted with a product, such as attempting to answer questions presented by the product. It does not necessarily mean that the child has correctly responded to questions presented by the product.

In particular, devices and products that can address a gap in the user's curriculum or that can address a perceived area of weakness can be suggested. For example, the metrics in the summary of usage report can be compared against established benchmarks to identify areas of study or skill sets where more emphasis may be beneficial. Then, products and devices that teach or reinforce those skill sets can be identified. The skill sets each product is designed to promote can also be listed. In other words, products can be mapped to skill sets, and skill sets can be mapped to products and devices, making it easier for parents to pick-and-choose the device/product most suitable for their child's needs or interests.

The recommendations may also include activities that can be performed without using the portable device 110. For example, executable links (hyperlinks) can be provided to printable worksheets that are completed manually or experientially instead of electronically.

The various pieces of information described above are presented in a user-friendly format (e.g., a Web-based GUI). FIGS. 2, 3, 4, 5, 6 and 7 are examples of on-screen GUIs according to embodiments of the invention. The GUIs are, in essence, Web pages produced by the server-based application 132 (FIG. 1). While the format of the GUIs is generally the same for each user, each GUI is populated with user-specific information drawn from the user's profile and account. The GUIs described below are presented after a parent or other authorized person has properly and securely logged into a particular user account.

While particular examples of GUIs are described below, embodiments according to the present invention are not limited to the content or format of those examples. That is, variations in the way the GUIs are formatted are permissible, and the content may be distributed across the GUIs in different ways (e.g., content shown as appearing within one Web page may be distributed among multiple Web pages, and vice versa).

With reference first to FIG. 2, the GUI 200 provides an overview of the more detailed information available within the account. The GUI 200, as well as other GUIs described herein, is organized in a top-down manner, such that broader types of information are presented at the top of the page, while more detailed information appears as the user scrolls down the page. Also, broader types of information are generally presented on the left-hand side of the page, with more detailed information appearing on the right-hand side of the page.

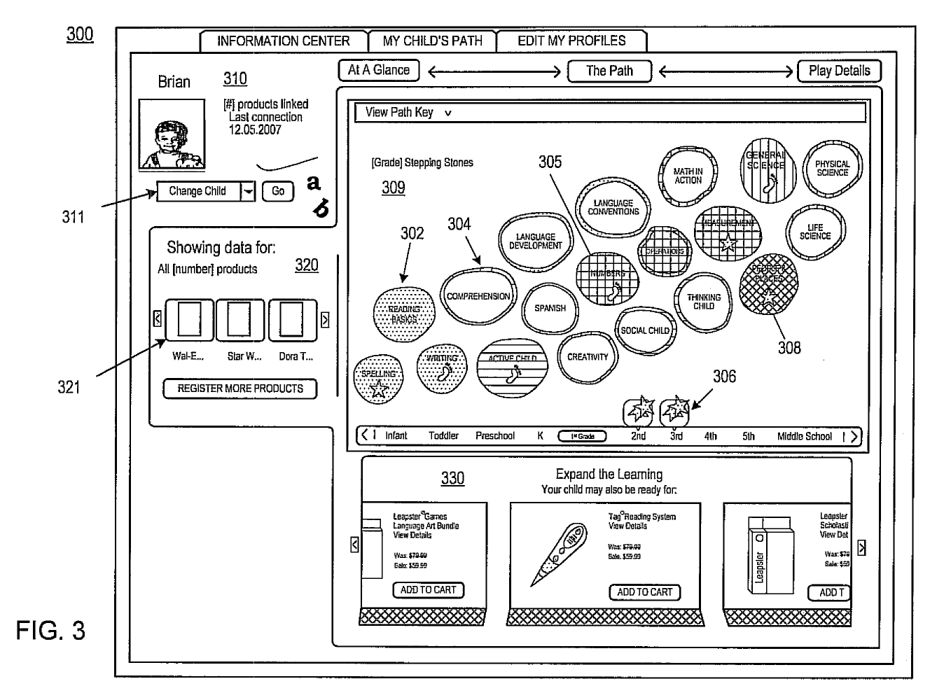

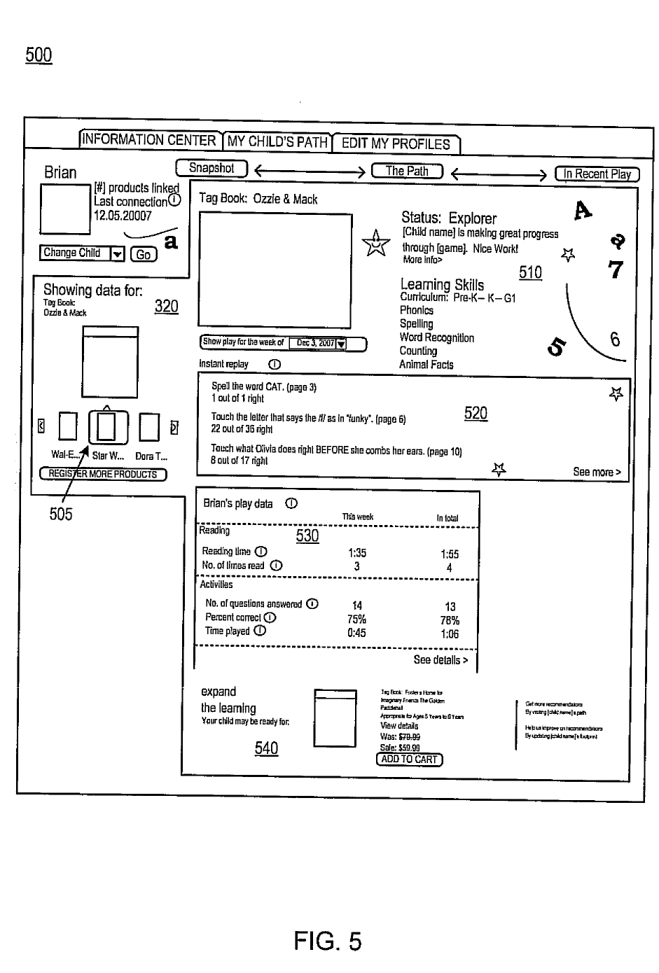

In the example of FIG. 2, the GUI 200 includes an icon 210 that, when activated (e.g., when clicked on using a mouse-controlled cursor), directs the viewer (e.g., a parent) to a GUI 300 (FIG. 3) that provides additional details regarding the child's learning progress. The GUI 200 also includes a region 220 that presents a listing of recent products that the user of interest (e.g., a child) has recently engaged (played with). By selecting a product in the list (e.g., by clicking on a product in the list using a mouse), the viewer is directed to a GUI 500 (FIG. 5) that provides additional details of the user's interaction with that product.

With reference to FIG. 3, the GUI 300 includes a region 310 that identifies the user profile currently being viewed. A dropdown menu 311 can be used to readily transfer to a different user profile if, for example, there is more than one user profile registered in the account. Thus, parents that have more than one child can readily move between user profiles so that, for example, metrics for one child and then for another child can be explored without having to log into different accounts.

The region 320 includes a carousel of products (e.g., games, books, etc.) that are currently registered with the account. The viewer can bring other products into view using the arrow buttons on either side of the region 320. Each product is represented with an icon such as the icon 321. By activating the icon 321, the viewer is directed to the GUI 500 (FIG. 5), which provides additional details of the user's interaction with that product.

The GUI 300 of FIG. 3 includes a region 309 that includes a number of indicia or icons that are referred to herein and elsewhere as “stepping stones” or simply “stones.” In general, the indicia correspond to a number of subject areas. In one embodiment, each stone is outlined with a particular color, and the stones may be filled with the color white or they may be filled with some color other than white. As elaborated on further below, a stone can be filled with a color (other than white) if a product associated with that stone has been registered. In general, in one embodiment, the stones are color-coded to map the stones to a particular subject area or curriculum. More specifically, the stones associated with a particular subject area may all have the same color. For example, stones associated with mathematics may be associated with the color blue, while stones associated with language and literacy may be associated with the color yellow.

There may be multiple skill sets (stones) associated with a given subject area. For example, there may be multiple stones associated with the subject area of language and literacy. Each stone includes a label that identifies a skill set or learning category with which it is associated. For example, within the subject area of language and literacy, one stone may be labeled “reading basics” and another stone may be labeled “spelling.” As noted above, each stone associated with a particular skill set or learning category is colored the same.

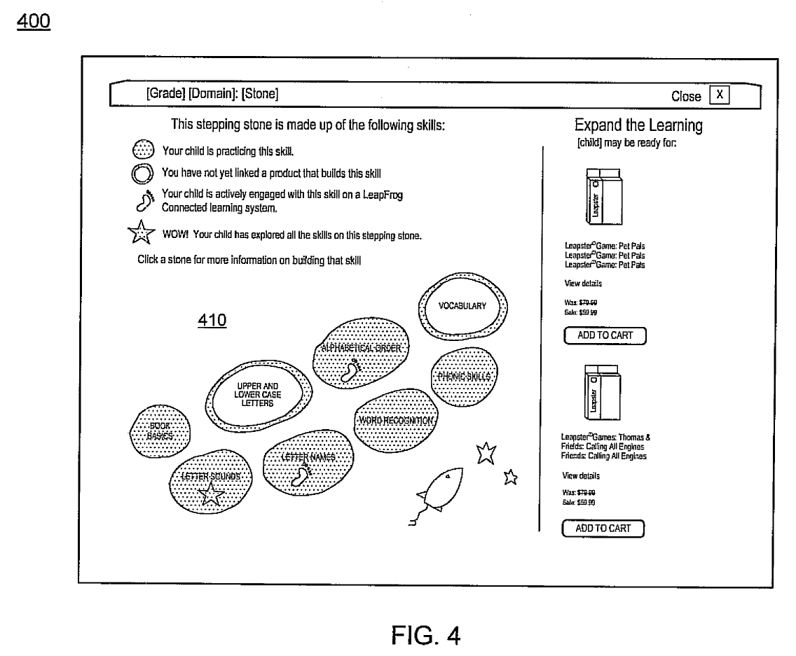

By activating (clicking on) a stone, the viewer is presented with the GUI 400 of FIG. 4. The GUI 400 includes a listing 410 of the skill areas associated with a particular stone. In the example of FIG. 4, the listing 410 is represented using additional stones. Each stone in the listing 410 is labeled in a manner similar to that just described. Thus, for example, by clicking on the stone 302 (“reading basics”), stones labeled “book basics,” “letter sounds” and so on are displayed in the GUI 400.

Moreover, by activating a stone within the GUI 400, another window (not shown) is opened that lists the specific behaviors and skills the user needs to exhibit in order to be considered as having mastered the skill set for that stone. In general, there is a hierarchy associated with the stones. The stones in the GUI 300 represent the highest level in the hierarchy, the stones in the GUI 400 represent the next highest level in the hierarchy, and so on.

With reference again to FIG. 3, generally speaking, there is a product or products that teaches and reinforces the skill set associated with each stone in the region 309. In general, each product is associated with more than one stone, and the skill sets associated with each stone may be taught by more than one product and/or device.

For example, a particular video game may include lessons and questions in its gameplay that teach and reinforce the skill set associated with at least the stone 302. Accordingly, in the example of FIG. 3, the stone 302 is filled with a color (other than white). In general, in one embodiment, a stone is filled with color (other than white) when a product associated with that stone is registered with the current account. In other words, in one embodiment, a stone having a non-white color indicates that a product associated with the skill set associated with that stone has been registered. In such an embodiment, a stone such as the stone 304 is not filled with color (other than white) because a product associated with that stone is not registered with the account—there is a product that teaches the skill set associated with the stone 304; however, that product has not been registered with the current account. In general, stones associated with registered products are readily distinguishable from stones not associated with registered products.

The region 330 of the GUI 300 includes a carousel of products and devices. In particular, the products and devices included in the region 330 are the products and devices associated with those stones that are not filled with a color other than white. That is, the region 330 includes products and devices that are available to the user but have not been registered by the user. By activating (clicking on) a stone that is not filled with color, products and devices specifically associated with that stone are highlighted in the region 330. In other words, the region 330 may show a complete listing of unregistered devices and products. However, if a parent is interested in addressing a particular skill set not addressed by a registered product/device, the parent can click on the stone associated with that skill set, and as a result the products/devices in the region 330 that are associated with that skill set/stone will be visibly highlighted in some manner. For example, product details may be presented in a new window. Also, by clicking on a product within the carousel in the region 330, the stones associated with that product are visibly highlighted in a similar manner.

Some stones may contain an icon 305, represented in FIG. 3 as a footprint. The icon 305 is used to identify which skill sets (which stones) the user is actively engaged with. Another type of icon, such as the icon 308 represented in FIG. 3 as a star, is used to indicate when the child user has explored all of the skills associated with a particular skill set (e.g., associated with a particular stone). Depending on the educational content of products, a child may need to explore multiple products in order to explore all of the skills associated with a particular skill set. In other words, skill sets may span one or more products. In an alternative embodiment, another type of icon (e.g., a “shooting star” icon such as the icon 306) may be displayed if the child engages in skills above the child's grade level. In general, information about, for example, a child's current interests and skills are highlighted in a clearly visible manner, so that parents can readily monitor their child's learning progress and identify their child's accomplishments.

In the example of FIG. 3, the region 309 includes stones associated with the first grade. In general, the region 309 includes different stones depending on grade level or age group. In the example of FIG. 31 a taskbar below the region 309 can be used to change the display to show stones for different grade levels or age groups. Thus, parents can be presented with different learning options as the child grows older or if the child advances past his or her current grade/age level. While products may generally be focused on a particular age group or grade level, some products may span multiple age groups or grade levels, allowing the child to advance naturally from one level of difficulty to the next. As mentioned above, another type of icon (the icon 306) can be used to indicate that the user has engaged learning categories and skill sets (stones) beyond the currently displayed grade level or age group. In other words, a child may be playing a game or reading at a level higher than that generally associated with his or her age group or grade level and, if so, this information is readily apparent to the parent. Thus, parents can identify a child's strengths and interests.

Although the stones in the region 309 appear to be arranged in some sort of hierarchy, that is not necessarily the case. Stones that are associated with the same subject area (e.g., that have the same color) may be clustered, and within each cluster, stones that are associated with registered products (e.g., filled with color) may be clustered. Furthermore, stones that are labeled with the icon 305, indicating that those stones have been actively engaged by the user, may be organized from left to right. In other words, as stones are filled with color and actively engaged, they may be rearranged within the region 309 as a means of illustrating progress through the stones currently being displayed.

Now with reference to FIG. 5, the GUI 500 provides metrics and other information associated with a particular product (e.g., a particular book or video game). As mentioned above, the region 320 includes a carousel of registered products. In the example of FIG. 5, the icon 505 in the region 320 has been selected and, as a result, metrics and other information associated with the product identified by the icon 505 are presented in the regions 510, 520 and 530.

The region 510 identifies the various skills associated with the currently displayed product. The skills listed in the region 510 can be mapped to the stones in the GUI 300 and the GUI 400 of FIGS. 3 and 4, respectively.

The region 520 of FIG. 5 identifies the various questions and prompts that were presented to the user while the user was interacting with the product currently displayed, as previously described herein. The information presented in the region 520 is based on the responses logged by the portable device 110 (FIG. 1) while the user used that device to interact with the currently displayed product. Various metrics associated with the user's responses can be displayed. In the example of FIG. 5, the number of times each question/prompt is encountered by the user, and the number of times that the user responded correctly to the question/prompt, are presented.

Furthermore, for products such as books, the location (e.g., page number) in the book associated with the question/prompt can be identified, so that the viewer can quickly locate it within the product. In one embodiment, an image of the page associated with the question/prompt can be displayed within the GUI 500 for quick reference. In general, in a static product such as a book, prompts and questions can be readily mapped to specific locations in the product. If, for example, a parent notices that a child is having a problem grasping the correct answer to a particular question, then the parent can locate the point in the book corresponding to the question and properly assist the child.

The region 530 includes a compilation of various metrics associated with the child user's interactions with the currently displayed product. The information presented in the region 530 is based on the responses logged by the portable device 110 (FIG. 1) while the user used that device to interact with the currently displayed product. For example, the amount of time and the number of times the product was used, the number of questions asked, and the number or percentage of correct answers can be displayed.

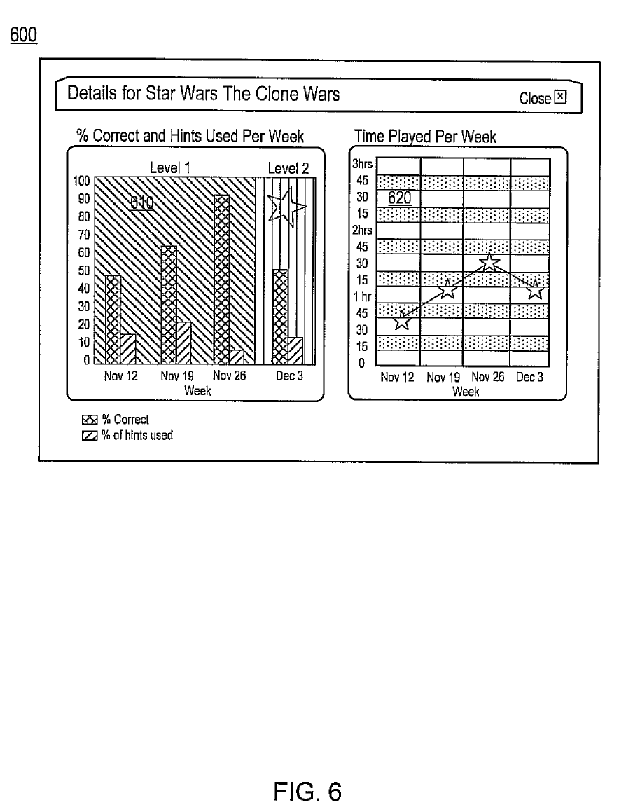

The various metrics presented in the regions 520 and 530 may be graphically represented in the manner exemplified by the GUI 600 of FIG. 6. In the example of FIG. 6, the region 610 shows the percentage of correct answers and the number of hints used for a particular product, and the region 620 shows the number of times the product was used, aggregated by week so that trends can be readily spotted.

As previously described herein, recommendations targeted to the user can be provided, in order to help the user progress to the next level of learning or to address gaps in the user's curriculum. For example, the metrics in the summary of usage report can be compared against established benchmarks to identify areas of study or skill sets where more emphasis or greater challenges may be beneficial. Other information input to the report, such as standardized test scores and report card grades, can also be considered. Then, products and devices that teach or reinforce the identified skill sets can be selected. In the example of FIG. 5, the region 540 includes suggested products and devices that may be helpful to the user in the manner just described.

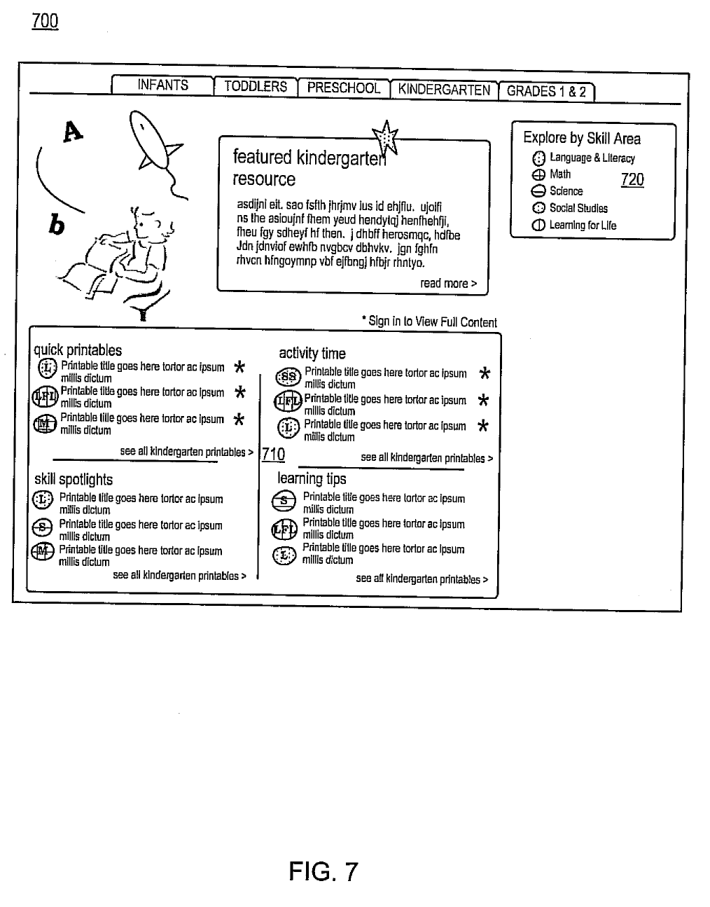

FIG. 7 illustrates a GUI 700 that lists activities (specifically, links to activities) and other resources that can be used to reinforce skills learned using the portable device 110 in combination with the products 112 and 114 of FIG. 1. For example, the region 710 of the GUI 700 includes links to a variety of experiential activities that can be performed around the house or in the neighborhood. The region 710 can also include links to a variety of printable activities (e.g., worksheets) that can be completed manually. In the example of FIG. 7, the region 710 also includes links to resources such as articles by educational experts and professionals.

Each of the items listed in the region 710 is marked by a stone, so that each item can be associated with a particular skill set or subject area. The region 720 is used to navigate to a list of links to activities, worksheets, articles and the like associated with a single particular subject or skill area (e.g. with a single stone).

To summarize, using the GUI described in conjunction with FIGS. 2-7, parents can be better informed about their child's interests, skills and progress. At a glance, parents can determine how often their children interact with a particular product or device, which skill sets their children are engaging with, the kinds of questions being answered, and how the children's learning is progressing. Also, parents can personalize and guide each child's learning process to reinforce areas of strength and address areas where more work is needed. For example, parents can choose from suggested (targeted) products and devices to fill gaps in their child's curriculum or to address specific areas of study.

The server-based application 132 (FIG. 1) can be used to provide functionality in addition to that described above. For example, emails (or other forms of communication such as text messages or instant messages) can be automatically sent to parents (or other authorized persons such as grandparents, teachers, or other third parties) when particular achievements or trends in their children's performance are detected. As noted above, the metrics in the summary of usage report can be compared to standardized benchmarks to provide an indication of a child's progress relative to the progress of others. Thus, for example, an email message or other type of alert can be sent to parents if their child's metrics exceed or fall short of the standardized benchmarks. As another example, as described above in conjunction with FIG. 3, an icon 305, an icon 306 and an icon 309 are used to identify, respectively, when a child has engaged a particular skill set, when the child has engaged a skill set beyond their grade level or age group, and when the child user has explored all of the skill sets associated with a particular stone. Accordingly, an alert such as an email message can be sent to the parent in response to one of these events occurring. In other words, it is not necessary for the server-based application 132 to wait for a parent to access their account to learn about their child's progress; instead, the same functionality that allows the server-based application to flag a child's progress can be used to initiate an alert to a parent.

Moreover, information in the summary of usage report, as well as other information about the user, can be used to customize the curricular content of a particular product to the user's skill/task level. The customized content can be in the form of standardized data structures that are used across multiple applications on a single platform and across multiple platforms. In essence, products can be actively molded for the user based on the user's performance as measured by the information logged by the portable device 110 (FIG. 1).

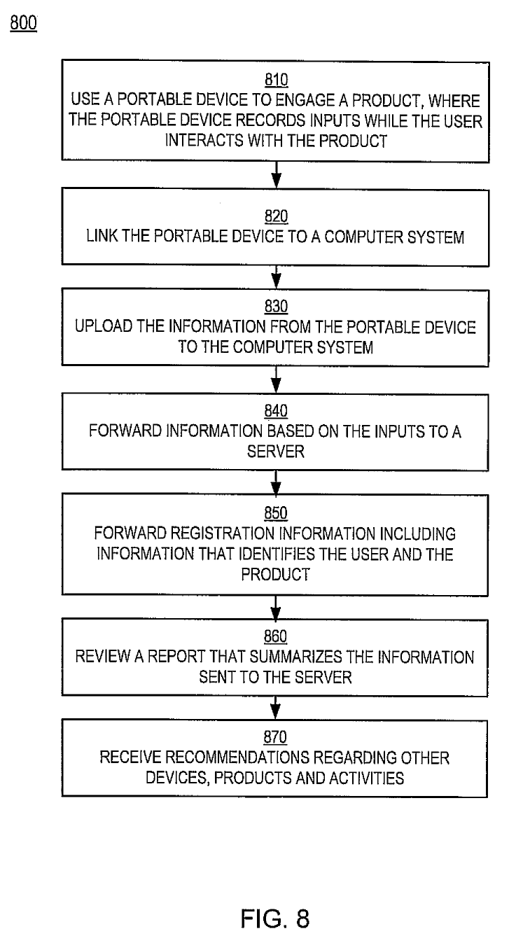

FIG. 8 is a flowchart 800 of a method for monitoring a user's learning progress according to an embodiment of the invention. Although specific steps are disclosed in the flowchart 800, such steps are exemplary. That is, embodiments of the present invention are well-suited to performing various other steps or variations of the steps recited in the flowchart 800. Certain aspects of the method of the flowchart 800 can be implemented as computer-executable instructions residing on some form of computer-usable medium in an electronic device.

In block 810 of FIG. 8, with reference also to FIG. 1, a user uses a stand-alone portable device 110 to engage and interact with a product 112/114. As part of that interaction, the user responds to questions and prompts. As described above, the user's responses (inputs and actions), as well as other types of information, are logged by the portable device.

In block 820, at some point after the user is finished interacting with the product 112/114, the portable device 110 is communicatively linked to a computer system 120 via a wired or wireless connection.

In block 830, the information logged in block 810 is uploaded to the computer system 120. The information can be uploaded automatically once the connection of block 820 is made—that is, the act of connecting may trigger the upload.

In block 840, which may be parallel with block 830, information based on the logged user inputs and other recorded information is forwarded from the computer system 120 to a server 130. That is, the raw recorded user inputs may be sent to the server 130, or the computer system 120 may process the recorded user inputs to some extent before forwarding the inputs to the server. Processing can also be performed on the portable device 110.

In block 850, registration information is also sent to the server 130. As previously described herein, at some point in time, either as part of the ongoing process or beforehand, an account including a user profile is created for the user on the server 130. The registration information included in block 850 may include the information used to create the account and user profile. After the account and user profile are created, the registration information referred to in block 850 can include information that identifies the user associated with the input data of block 840, and information that identifies the product 112/114 that the user interacted with in block 810. The identity of the portable device 110 is inherent in the identity of the product 112/114, although the registration information may instead specifically identify the portable device.

In block 860 of FIG. 8, and with reference also to FIG. 1, a user-specific summary of usage report is prepared by the server-based application 132 and viewed at the computer system 120 using the browser 124. Additional details regarding the summary of usage report are presented above, in particular in conjunction with FIGS. 2-6.

In block 870, again with reference to FIGS. 1 and 8, in addition to or as part of the user-specific summary of usage report, recommendations regarding other devices, products and activities are identified by the server-based application 132, where they can be reviewed using the browser 124. Additional details regarding the recommendations are presented above, in particular in conjunction with FIGS. 3, 5 and 7.

In summary, according to embodiments of the present invention, the effectiveness of technology-based learning devices and related products is increased by giving parents the capability to see and measure what their children are actually learning, so that progress can be tracked and areas of strength as well as areas where extra attention may be needed can be identified.

Embodiments of the present invention are thus described. While the present invention has been described in particular embodiments, it should be appreciated that the present invention should not be construed as limited by such embodiments, but rather construed according to the below claims.

What is claimed is:

1. In a computer system comprising a display for displaying a graphical user interface (GUI), a method of tracking a user's learning progress, said method comprising:
forwarding first information to a server, said first information comprising responses by a user while said user interacts with a product using a stand-alone first portable device, said responses logged by said first portable device and subsequently uploaded to said computer system, said first information further comprising registration information that identifies said user and that also names said product;
receiving second information from said server; and
rendering said GUI based on said second information, wherein said GUI comprises a report that summarizes said first information forwarded from said computer system, said GUI further comprising names of products selected based on said first information.

2. The method of claim 1 wherein said GUI further comprises a plurality of indicia corresponding to a plurality of subject areas, wherein one or more skills said product is designed to promote are associated with each of said subject areas.

3. The method of claim 2 wherein said plurality of indicia comprises a plurality of colors.

4. The method of claim 2 wherein said GUI further identifies skills within a subject area that has been engaged by said user.

5. The method of claim 1 wherein said GUI further comprises a listing comprising a plurality of product names that said user interacted with over a particular interval of time and summary information for each product named in said listing.

6. The method of claim 5 wherein said summary information is selected from the group consisting of two or more of the following: user name; percentage of correct inputs; percentage of incorrect inputs; number of times a help function is invoked; and curriculum.

7. The method of claim 5 wherein said plurality of product names includes products that work with said first portable device and products that work with a different stand-alone second portable device.

8. The method of claim 7 wherein said report comprises a summary of information logged by said first portable device and information logged by said second portable device.

9. The method of claim 1 wherein said report comprises summary information for different time periods.

10. A graphical user interface (GUI) for display on a display device, said GUI comprising:
a report that summarizes responses by a child user recorded by a stand-alone first portable device while said child user interacts with a product using said first portable device, said responses logged by said first portable device and subsequently uploaded to a computer system that forwards information comprising said responses to a server, said information further comprising registration information that identifies said child user and that also names said product; and
names of products selected based on said registration information.

11. The GUI of claim 10 further comprising a plurality of indicia corresponding to a plurality of subject areas, wherein one or more skills said product is designed to promote are associated with each of said subject areas.

12. The GUI of claim 11 wherein said plurality of indicia comprises a plurality of colors.

13. The GUI of claim 11 wherein said GUI further identifies skills within a subject area that has been engaged by said user.

14. The GUI of claim 10 further comprising a listing comprising a plurality of product names that said user interacted with over a particular interval of time and summary information for each product named in said listing.

15. The GUI of claim 14 wherein said summary information is selected from the group consisting of two or more of the following: user name; percentage of correct inputs; percentage of incorrect inputs; number of times a help function is invoked; and curriculum.

16. The GUI of claim 14 wherein said plurality of product names includes products that work with said first portable device and products that work with a different stand-alone second portable device.

17. The GUI of claim 16 wherein said report comprises a summary of information logged by said first portable device and information logged by said second portable device.

18. The GUI of claim 10 further comprising summary information for different time periods.

19. A computer-readable medium having computer-executable instructions for performing a method of facilitating a user's learning progress, said method comprising:
forwarding first information via the Internet to a server, said first information comprising inputs made by a user in response to prompts, said user providing said inputs while interacting with a product using a stand-alone first portable device, said inputs logged by said first portable device and subsequently uploaded to said computer system, said first information further comprising registration information that identifies said user and that also names said product; and
displaying a graphical user interface (GUI) comprising a report specific to said user that summarizes said first information forwarded to said server and further comprising names of products selected based on said first information.

20. The computer-readable medium of claim 19 wherein said GUI further comprises a plurality of indicia corresponding to a plurality of subject areas, wherein one or more skills said product is designed to promote are associated with each of said subject areas.

21. The computer-readable medium of claim 20 wherein said plurality of indicia comprises a plurality of colors.

22. The computer-readable medium of claim 20 wherein said GUI further identifies skills within a subject area that has been engaged by said user.

23. The computer-readable medium of claim 19 wherein said GUI further comprises a listing comprising a plurality of product names that said user interacted with over a particular interval of time and summary information for each product named in said listing.

24. The computer-readable medium of claim 23 wherein said summary information is selected from the group consisting of two or more of the following: user name; percentage of correct inputs; percentage of incorrect inputs; number of times a help function is invoked; and curriculum.

25. The computer-readable medium of claim 23 wherein said plurality of product names includes products that work with said first portable device and products that work with a different stand-alone second portable device.

26. The computer-readable medium of claim 25 wherein said report comprises a summary of information logged by said first portable device and information logged by said second portable device.

27. The computer-readable medium of claim 19 wherein said report comprises summary information for different time periods.
